(19) United States
(12) Patent Application Publication
(10) Pub. No.: US 2026/0360006 A1
(43) Pub. Date: Nov. 12, 2026

(54) STATE ESTIMATION DEVICE, STATE ESTIMATION METHOD AND STORAGE MEDIUM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Ryusuke OHATA, Nisshin-shi (JP)

(21) Appl. No.: 19/556,782

(22) Filed: Mar. 4, 2026

(30) Foreign Application Priority Data
May 8, 2025 (JP) 2025-078043

(51) Int. Cl. G06T 7/73; G06T 7/246; G06V 20/56

(52) U.S. Cl. CPC G06T 7/73; G06T 7/246; G06V 20/56

(57) ABSTRACT

A state estimation device includes a first estimation unit, a second estimation unit, a Coriolis force calculation unit, and a final estimation unit. The first estimation unit calculates a first estimated value corresponding to an estimated value of state based on image data acquired by an imaging device. The second estimation unit calculates a second estimated value corresponding to an estimated value of state based on inertial data acquired by an inertial measurement unit. The Coriolis force calculation unit calculates a Coriolis term corresponding to a Coriolis force based on the inertial data. The final estimation unit calculates a final estimate of final state based on the first estimated value, the second estimated value, and the Coriolis term.

### CROSS REFERENCE TO RELATED APPLICATION

This application is based on Japanese Patent Application No. 2025-078043 filed on May 8, 2025, the disclosure of which is incorporated herein by reference.

### TECHNICAL FIELD

The present disclosure relates to a state estimation device and a state estimation method.

### BACKGROUND

Various techniques have been proposed to estimate state of a movable body such as a vehicle, on which a camera and an inertial measurement unit are mounted.

### SUMMARY

According to one aspect of the present disclosure, a state estimation device includes at least one of (i) a circuit and (ii) a processor with a memory storing computer program code executable by the processor. The at least one of the circuit and the processor may be configured to cause the state estimation device to: acquire image data from an imaging device; calculate a first estimated value corresponding to an estimated value of a state of a movable body estimated based on the image data, the state including at least one of a position, a velocity, and an orientation of the movable body; acquire inertial data from an inertial measurement unit; calculate a second estimated value corresponding to an estimated value of the state estimated based on the inertial data; calculate a Coriolis term corresponding to a Coriolis force based on the inertial data; and calculate a final estimated value of the state based on the first estimated value, the second estimated value, and the Coriolis term.

### BRIEF DESCRIPTION OF DRAWINGS

FIG. 1 is a plan view showing a schematic configuration of a vehicle as a movable body to which a state estimation device of an embodiment is applied.

FIG. 2 is a block diagram showing a schematic functional configuration of the state estimation device shown in FIG. 1.

FIG. 3 is a conceptual diagram showing an outline of operation of the state estimation device shown in FIG. 2.

FIG. 4 is a conceptual diagram showing an outline of operation of the state estimation device shown in FIG. 2.

### DETAILED DESCRIPTION

Various techniques have been proposed to estimate the state of a movable body, such as a vehicle, on which a camera and an inertial measurement unit are mounted. For example, the position, velocity, or orientation of the vehicle is estimated using the camera and the inertial measurement unit. The inertial measurement unit detects three-dimensional inertial motion, and outputs translational motion and rotational motion in three orthogonal axial directions as inertial data.

In this type of technology, efforts are being made to further improve the estimation accuracy. The present disclosure has been made in view of the circumstances and the like exemplified above.

According to one aspect of the present disclosure, a state estimation device is configured to estimate a state including at least one of a position, a velocity, and an orientation of a movable body. The state estimation device includes: an image data acquisition unit configured to acquire image data from an imaging device; a first estimation unit configured to calculate a first estimated value corresponding to an estimated value of the state based on the acquired image data; an inertial data acquisition unit configured to acquire inertial data from an inertial measurement unit; a second estimation unit configured to calculate a second estimated value corresponding to an estimated value of the state based on the acquired inertial data; a Coriolis force calculation unit configured to calculate a Coriolis term corresponding to a Coriolis force based on the acquired inertial data; and a final estimation unit configured to calculate a final estimated value of the state based on the first estimated value, the second estimated value, and the Coriolis term.

According to another aspect of the present disclosure, a state estimation method of estimating a state including at least one of a position, a velocity, and an orientation of a movable body includes: acquiring image data from an imaging device; calculating a first estimated value corresponding to an estimated value of the state based on the acquired image data; acquiring inertial data from an inertial measurement unit; calculating a second estimated value corresponding to an estimated value of the state based on the acquired inertial data; calculating a Coriolis term corresponding to a Coriolis force based on the acquired inertial data; and calculating a final estimated value of the state based on the first estimated value, the second estimated value, and the Coriolis term.

Hereinafter, exemplary embodiments or specific examples of the present disclosure will be described with reference to the drawings as appropriate. It should be noted that the following embodiments, their variations, and the accompanying drawings are simplified or schematically presented to concisely explain the contents of the present disclosure and do not limit the scope of the present disclosure. The descriptions in the drawings may not necessarily correspond exactly to the specific device configurations that are actually manufactured and sold. In other words, the present disclosure should not be interpreted in a limited manner by the descriptions in the drawings and the corresponding descriptions of the device configurations, functions, or operations that will be explained below.

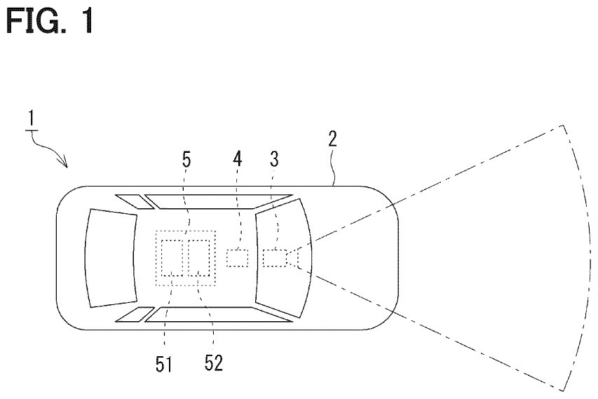

Referring to FIG. 1, a vehicle 1 as a movable body according to this embodiment has the basic configuration of a standard automobile that travels on road. The vehicle 1 has a body 2, in which a driving force generating mechanism, a driving force transmitting mechanism, an imaging device 3, an inertial measurement unit 4, and a state estimation device 5 are arranged.

The imaging device 3 is configured to generate image data by capturing an image of the surroundings of the vehicle 1 and to output the generated image data to the state estimation device 5. In this embodiment, the imaging device 3 has a configuration as a so-called visible light camera equipped with an imaging element such as a CCD or CMOS. CCD is an abbreviation for Charge Coupled Device. CMOS is an abbreviation for Complementary Metal Oxide Semiconductor.

The inertial measurement unit 4 is configured to detect three-dimensional inertial motion of the vehicle 1, specifically, translational motion and rotational motion in three orthogonal axial directions, and to output the detected inertial data to the state estimation device 5. The inertial measurement unit 4 may be referred to as an IMU.

More specifically, the inertial measurement unit 4 includes a gyro sensor to detect the angular velocity ωx, ωy, ωz of the vehicle 1 as rotational motion, and an acceleration sensor to detect the acceleration fx, fy, fz of the vehicle 1 as translational motion. In this embodiment, the inertial measurement unit 4 has a configuration as a small MEMS-based IMU. MEMS is an abbreviation for Micro Electro Mechanical Systems.

The state estimation device 5 is configured to estimate a state including at least one of the position, velocity, and orientation of the vehicle 1 based on image data acquired from the imaging device 3 and inertial data acquired from the inertial measurement unit 4. In this embodiment, the state estimation device 5 estimates the vehicle state using a visual inertial odometry (VIO) technique. Hereinafter, the state of the vehicle 1 that is the subject of estimation by the state estimation device 5 will be referred to as the “vehicle state” for short.

In this embodiment, the state estimation device 5 has a configuration as a so-called ECU. ECU is an abbreviation of Electronic Control Unit. Specifically, the state estimation device 5 has a configuration as a so-called on-board computer, which includes at least a calculation device 51 and a storage device 52.

The calculation device 51 is composed of at least one CPU, MPU, or the like. CPU stands for Central Processing Unit. MPU stands for Micro Processor Unit.

The storage device 52 is configured by at least one non-transitory tangible storage medium such as a ROM or a non-volatile rewritable memory. ROM stands for Read Only Memory. The non-volatile rewritable memory is configured so that information can be rewritten while the power is on, but the information is retained so that it cannot be rewritten while the power is off. The non-volatile rewritable memory may be flash ROM or magnetic recording device.

The storage device 52 stores computer programs as well as various data such as initial values, maps, look-up tables, etc., required to execute the programs. The state estimation device 5 is configured to perform operations of estimating the vehicle state since the calculation device 51 reads and executes a state estimation program stored in the storage device 52.

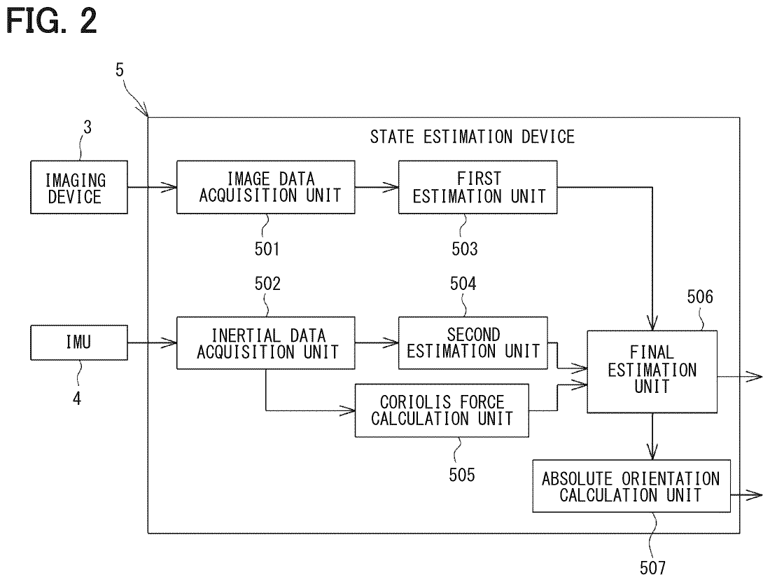

FIG. 2 shows an example of functional block configuration realized by the calculation device 51 of the state estimation device 5 by reading out and executing a vehicle state estimation program, which is a computer program, from the storage device 52. Hereinafter, an outline of the functional configuration of the state estimation device 5 according to this embodiment will be described with reference to FIG. 2.

As shown in FIG. 2, the state estimation device 5 includes, as functional components realized by executing a computer program, an image data acquisition unit 501, an inertial data acquisition unit 502, a first estimation unit 503, a second estimation unit 504, a Coriolis force calculation unit 505, a final estimation unit 506, and an absolute orientation (azimuth) calculation unit 507. Note that these functional configurations are provided for the sake of convenience in order to explain the functions performed by the state estimation device 5, and do not mean that corresponding software routines or hardware units exist separately and independently.

The image data acquisition unit 501 acquires or receives image data from the imaging device 3 and temporarily stores and holds the image data. The inertial data acquisition unit 502 acquires or receives inertial data from the inertial measurement unit 4 and temporarily stores and holds the inertial data.

The first estimation unit 503 calculates a first estimated value corresponding to an estimated value of the vehicle state based on the image data acquired by the image data acquisition unit 501. Specifically, the first estimation unit 503 has a function as an image processing unit that extracts feature points from the image data and tracks the feature points. That is, the first estimated value is a time trajectory of at least one of the position, velocity, and azimuth angle of the vehicle 1 calculated by image processing.

Such an image processing unit extracts feature points based on local features using, for example, SIFT or SURF, and matches the feature points extracted in the current image frame with the feature points extracted in the previous image frame using nearest neighbor search or the like. SIFT is an abbreviation for Scale Invariant Feature Transform. SURF is an abbreviation for Speeded-Up Robust Features. The extraction of feature points and the association of feature points in the image processing unit may be achieved by means other than those described above.

The second estimation unit 504 calculates a second estimated value corresponding to the estimated value of the vehicle state based on the inertial data acquired by the inertial data acquisition unit 502. Specifically, the second estimation unit 504 is configured to calculate the time trajectory of at least one of the position, velocity, and azimuth angle of the vehicle 1 as a second estimated value by integrating the acceleration and angular velocity contained in the inertial data. The second estimation unit 504 may also be referred to as an inertial processor.

More specifically, the second estimation unit 504 integrates the angular velocity, which is the sensor output of the gyro sensor, to obtain the orientation and rotation matrix of the vehicle 1. Further, the second estimation unit 504 integrates the product of the acceleration, which is the sensor output of the acceleration sensor, and the rotation matrix, to obtain the speed of vehicle 1. The second estimation unit 504 further integrates the obtained speed of vehicle 1 to calculate the position of vehicle 1. The second estimation unit 504 calculates three azimuth angles, namely, a roll angle, a pitch angle, and a yaw angle, as orientation.

Regarding the functional configurations of the image data acquisition unit 501, the inertial data acquisition unit 502, the first estimation unit 503, and the second estimation unit 504, US 2023/0408261 A1 (corresponding to JP 2023-183773 A) is incorporated by reference.

Regarding the visual inertial odometry, a non-patent literature of T. Qin, P. Li and S. Shen, “VINS-Mono: A Robust and Versatile Monocular Visual-Inertial State Estimator,” in IEEE Transactions on Robotics, vol. 34, no. 4, pp. 1004-1020, August 2018 is incorporated by reference.

The Coriolis force calculation unit 505 calculates a Coriolis term corresponding to the Coriolis force based on the inertial data acquired by the inertial data acquisition unit 502. The Coriolis term is provided for suppressing a decrease in estimation accuracy that accompanies a deviation in the estimation result of the vehicle state between the inertial coordinate system and the earth-fixed coordinate system due to the influence of the rotation of the earth. The details of the Coriolis term and the background to its use will be explained in detail later when explaining the outline of the operations.

The final estimation unit 506 is configured to calculate a final estimated value, which is a final estimate of the vehicle state, based on the first estimated value, the second estimated value, and the Coriolis term. That is, the final estimation unit 506 calculates the final estimated value using visual inertial odometry based on the tracking results of feature points extracted from the camera image and the measurement results of inertial data by the inertial measurement unit 4. The final estimated value includes at least one of the position, velocity, azimuth angle, bias error, depth to feature point, and the like.

The final estimation unit 506 performs optimization calculation to minimize the bias error between the visual odometry calculation result by the first estimation unit 503 and the inertial odometry calculation result by the second estimation unit 504. The final estimation unit 506 in this embodiment further uses the Coriolis term in such optimization calculations. The details of such optimization calculations will also be explained when explaining the outline of the operations below.

The absolute orientation calculation unit 507 estimates the absolute azimuth angle as a vehicle state based on the final estimated value calculated by the final estimation unit 506. The absolute orientation calculation unit 507 calculates the absolute azimuth angle from the gravitational acceleration term and the earth's rotation angular velocity term calculated by the final estimation unit 506. The details of this calculation will also be explained when explaining the outline of the operations below.

Below, an overview of the operations executed due to the method and the program according to this embodiment will be described, along with a comparison example and effects achieved by this embodiment. In the following description, the state estimation device 5 and the state estimation method and the state estimation program executed thereby may be collectively referred to as “this embodiment.”

As is well known, in a comparison example, a vehicle state is roughly calculated by integrating the output of the IMU, and this is then combined with the results of calculating the vehicle state through image processing of the camera output to perform an optimization calculation, thereby calculating the vehicle state with relatively high accuracy. In this case, the integration of the IMU output is an integration in an inertial system different from the coordinate system of the camera output, and deviates from the integration value in the Earth-fixed coordinate system, which is the coordinate system of the camera output.

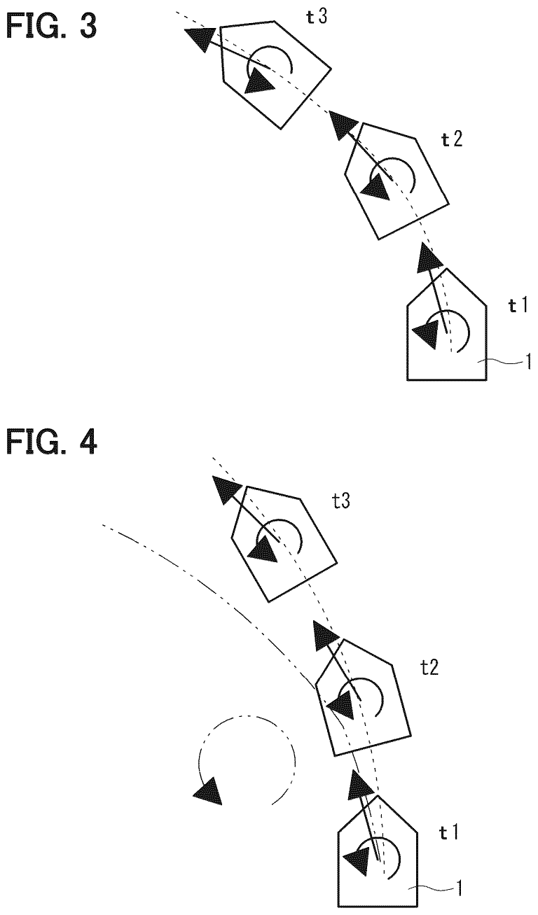

Specifically, FIG. 3 shows a movement trajectory of the vehicle 1 obtained from the output of the IMU. FIG. 4 shows a movement trajectory of the vehicle 1 obtained from the camera output. In FIG. 3 and FIG. 4, t1, t2, and t3 respectively indicate times. The straight arrow indicates the acceleration at each time, and the arc arrow indicates the angular velocity at each time.

Due to the effect of the Earth's rotation, the inertial frame of reference rotates when viewed from the Earth-fixed frame of reference. Therefore, the movement trajectory in the inertial space differs from the movement trajectory in the earth-fixed coordinate system. That is, as shown in FIG. 4, due to the rotation effect, the movement trajectory shown by the dashed line obtained from the camera output appears to be distorted by the amount of Coriolis force and to have less rotation than the original movement trajectory shown by the two-dot chain line. Such deviation of the locus tends to increase as the moving speed increases and the integration time increases.

As described above, conventional visual inertial odometry still has room for improvement in terms of the accuracy of optimization calculations. Here, in order to unify the coordinates, it is possible to consider Coriolis acceleration or to construct an attitude/orientation system using absolute orientation/azimuth. In this embodiment, the absolute azimuth is estimated by using a Coriolis term corresponding to the Coriolis force in the optimization calculation, and by taking this absolute azimuth into consideration, the estimation accuracy of the position, velocity and azimuth angle is improved.

Specifically, the operation of each functional component in the state estimation device 5 will be described below. First, the image data acquisition unit 501 acquires image data from the imaging device 3. The inertial data acquisition unit 502 acquires inertial data from the inertial measurement unit 4.

The first estimation unit 503 calculates a first estimated value corresponding to an estimated value of the vehicle state based on the image data acquired by the image data acquisition unit 501. Specifically, the first estimation unit 503 detects a feature point and assigns the time of detection to the feature point. The first estimation unit 503 performs a tracking process of the feature points using the feature points detected in the previous sampling and the image obtained in the current sampling, and links the previous sampling with the current sampling (i.e., assigns the same feature point ID). The above is repeated for a predetermined time. In this way, the first estimation unit 503 has functions as a feature point detecting unit, a time tagging unit, a feature point tracking unit, and a feature point information buffering unit.

The second estimation unit 504 calculates a second estimated value corresponding to the estimated value of the vehicle state based on the inertial data acquired by the inertial data acquisition unit 502. Specifically, the second estimation unit 504 integrates the inertial data to generate a time trajectory of the vehicle state for the same predetermined time period as above. The Coriolis force calculation unit 505 calculates a Coriolis term corresponding to the Coriolis force based on the inertial data acquired by the inertial data acquisition unit 502.

The final estimation unit 506 calculates a final estimated value, which is a final estimate of the vehicle state, based on the first estimated value calculated by the first estimation unit 503, the second estimated value calculated by the second estimation unit 504, and the Coriolis term calculated by the Coriolis force calculation unit 505. That is, the final estimation unit 506 performs optimization calculations using the feature point information, the time trajectory of the vehicle state based on the inertial data, and the Coriolis force, and obtains the vehicle state such as the position, speed, attitude angle, bias error, and depth to the feature points of the vehicle 1. At the same time, the gravitational acceleration and the angular velocity of the Earth's rotation in the inertial system are also obtained. The absolute orientation calculation unit 507 calculates the absolute orientation from the gravitational acceleration and the angular velocity of the Earth's rotation in the inertial system.

Hereinafter, vehicle state estimation in this embodiment, particularly the Coriolis term, will be described in detail using mathematical expressions.

In this embodiment, when integrating the IMU acceleration output, the acceleration is not simply integrated, but is calculated using Formula (1) to which a term due to the Coriolis force is added. The coordinate transformation matrix in Formula (1) corresponds to the Coriolis term, and the calculation of this is equivalent to calculate the azimuth orientation.

$${\dot{v}}^{b} = ( {f}^{b} + {b}_{a} ) + {C}_{n}^{b} {g}^{n} + 2 {v}^{b} \times ( {C}_{n}^{b} {ω}_{i , e}^{n} ) \qquad Formula ( 1 )$$

\dot{v}^{b}: acceleration after Coriolis force is added
f^{b}: IMU acceleration output
gⁿ: gravitational acceleration in Earth-fixed coordinate system
v^{b}: velocity

$${C}_{n}^{b} :$$

coordinate transformation matrix from Earth-fixed coordinate system to vehicle coordinate system (inertial coordinate system)

$${ω}_{i , e}^{n} :$$

Earth's rotation angular velocity in Earth-fixed coordinate system

In this embodiment, the coordinate transformation matrix is estimated in addition to the VIO output, that is, the position, velocity, and azimuth angle. For the estimation, Formula (2) and Formula (3) are used.

$${g}^{b} = {C}_{n}^{b} {g}^{n} \qquad Formula ( 2 )$$

$${ω}_{i , e}^{b} = {C}_{n}^{b} {ω}_{i , e}^{n} \qquad Formula ( 3 )$$

By integrating and rearranging Formula (1), the amount of positional movement T can be accurately approximated by Formula (4). The first term on the right side of Formula (4) is the position obtained by integrating only the IMU output f^{b}. The second term on the right side of Formula (4) is a first-order polynomial related to the acceleration bias. The third term on the right side of Formula (4) is a first-order polynomial related to the gravitational acceleration. The fourth term on the right side of Formula (4) is a first-order polynomial related to the Earth's rotation angular velocity.

$$T = \overline{T} + {h}_{1} ( {b}_{a} ) + {h}_{2} ( {g}^{b} ) + {h}_{3} ( {ω}_{i , e}^{b} ) \qquad Formula ( 4 )$$

T̅: position obtained by integrating only IMU output f^{b}
h₁(bₐ): first-order polynomial related to acceleration bias
h₂(g^{b}): first-order polynomial related to gravitational acceleration

$${h}_{3} ( {ω}_{i , e}^{b} ) :$$

first-order polynomial related to Earth's rotation angular velocity

In a comparison example of VIO, it is common to formulate and solve an optimization problem using position, velocity, azimuth angle, acceleration bias, angular velocity bias, and depth to feature points as target variables. In this regard, according to this embodiment, the gravitational acceleration and the Earth's rotation angular velocity are further added to the optimization target variables, and the optimization problem is solved to determine the gravitational acceleration “g” in the parentheses of the third term on the right side of Formula (4) and the Earth's rotation angular velocity “ω” in the parentheses of the fourth term on the right side of Formula (4).

A coordinate transformation matrix can be obtained from the term of gravitational acceleration “g” and the term of Earth's rotation angular velocity “ω”. The gravitational acceleration “g” in the Earth-fixed coordinate system is known, and the Earth's rotation angular velocity “ω” is also known. The term of gravitational acceleration “g” and the term of Earth's rotation angular velocity “ω” are calculated by the optimization calculations. Therefore, the only unknown variable is the term of coordinate transformation matrix, and can be calculated using a method such as Davenport Q-method and the like. The calculated coordinate transformation matrix becomes a variable that represents the absolute azimuth (orientation).

In the above optimization calculation, the optimization is performed taking into account the deviation of the coordinate system, so the accuracy of the position, velocity, and azimuth angle is improved. Therefore, according to this embodiment, compared to a comparison example that does not take the Coriolis force into consideration, the estimation accuracy of the position, velocity, azimuth angle and depth to the feature point is improved, and the absolute azimuth angle can be estimated at the same time. As described above, according to this embodiment, it is possible to further improve the accuracy of estimating the vehicle state compared to the comparison example.

### MODIFICATION

The present disclosure is not limited to the embodiment and the examples described above. The embodiment can be appropriately changed. Hereinafter, typical modifications will be described. In the following description of the modifications, differences from the embodiment will be mainly described. In the embodiment and the following modifications, the same reference numerals are assigned to the same or equivalent parts. Therefore, in the following description of the modifications, the description in the embodiment can be appropriately incorporated for the components having the same reference numerals as those in the embodiment, unless there is a technical contradiction or a special additional description.

The present disclosure is not limited to the specific applications and device configuration described in the above embodiment. For example, the vehicle 1 may be a so-called standard automobile, a large automobile, a two-wheeled vehicle, or a three-wheeled vehicle. Furthermore, the vehicle 1 may be one that runs not on public roads but within a specific site such as a factory. That is, there are no particular limitations on the type and use of the vehicle 1, the shape and size of the body 2, and the like. Furthermore, the application of the present disclosure is not limited to vehicle 1 but may also be to flying objects such as drones.

The imaging device 3 may be a so-called monocular camera or a compound eye camera. Furthermore, the imaging device 3 is not limited to a so-called visible light camera, but may be one that is sensitive in the infrared region.

The application of the present disclosure is not limited to VIO, but may also be LIO or VLIO. That is, the imaging device 3 is not limited to a camera, but may also be a LiDAR. LIO is an abbreviation for LiDAR-Inertial Odometry. VLIO stands for Visual-LiDAR Inertial Odometry. LiDAR is an abbreviation for Light Detection and Ranging or Laser Imaging Detection and Ranging.

The absolute azimuth calculated and output by the absolute orientation calculation unit 507 can be referred to as the “final estimated value,” similar to the final estimated value (e.g., position, velocity, azimuth angle, etc.) calculated and output by the final estimation unit 506. Therefore, the final estimation unit 506 and the absolute orientation calculation unit 507 can be evaluated as a single entity. Therefore, the present disclosure is not limited to a mode in which the final estimation unit 506 and the absolute orientation calculation unit 507 are provided as separate and independent functional configurations or functional blocks.

The state estimation device 5 may be an ECU for controlling the driving of the host vehicle. Such an ECU may also be called a driving control ECU, but may also be a driving assistance ECU or an autonomous driving ECU. The driving assistance ECU is configured to achieve driving automation level 1 or 2 as defined in the standard “SAEJ3016” published by SAE International. The autonomous driving ECU is configured to achieve any one of the driving automation levels 3 to 5 specified in the standard.

All or part of the state estimation device 5 may be configured to include a digital circuit, such as an ASIC or FPGA, configured to be able to realize the above-described functions or operations. Here, ASIC is an abbreviation for Application Specific Integrated Circuit. FPGA stands for Field Programmable Gate Array. That is, in the state estimation device 5, the on-board microcomputer portion and the digital circuit portion can coexist.

The computer program according to the present disclosure, which enables the execution of the various operations, procedures, or processes described in the above embodiments, can be downloaded or upgraded to a non-volatile rewritable memory via V2X communication using a communication device. V2X stands for Vehicle to X. Alternatively, such a computer program can be downloaded or upgraded via a terminal device provided at the vehicle's manufacturing plant, repair shop, dealer, or the like. The nonvolatile rewritable memory in which such a computer program is stored is not limited to a semiconductor memory such as a flash memory, but may also be an optical or magnetic recording medium or the like.

As described above, each functional configuration, processes and method described above may be implemented by a dedicated computer provided by configuring a processor and a memory programmed to execute one or plural functions embodied by a computer program. Alternatively, each functional configuration, processes and method described above may be implemented by a dedicated computer provided by configuring a processor with one or more dedicated hardware logic circuits. Alternatively, each functional configuration and processes described above may be implemented by one or more dedicated computers configured with a combination of at least one processor and at least one memory programmed to execute one or multiple functions and another processor configured using one or more hardware logic circuits.

The computer program may be stored in a computer-readable non-transitory tangible storage medium as an instruction to be executed by the computer. That is, each of the above functional configurations and processes can be expressed as a computer program including the procedures for realizing them, or as a non-transient tangible storage medium that stores the computer program.

The constituent element(s) of each of the above embodiments and the above modifications is/are not necessarily essential unless it is specifically stated that the constituent element(s) is/are essential in the above embodiments, or unless the constituent element(s) is/are obviously essential in principle. In addition, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as essential or is obviously essential in view of the principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

Similar expressions such as “acquisition”, “calculation”, “estimation”, “detection”, and “sensing” can be appropriately replaced with one another within a range free from technical conflict. Furthermore, the terms “exceeding the threshold value” and “equal to or greater than the threshold value” can be used interchangeably as appropriate within the scope of any technical contradiction. The same applies to “less than a threshold” and “equal to or greater than a threshold”.

The modifications are also not necessarily limited to the above examples. For example, all or part of one modification and all or part of another modification can be combined together as long as there is no technical conflict. Furthermore, all or part of the above-described embodiments and all or part of the above-described modifications may be combined together other as long as there is no technical conflict.

What is claimed is:

1. A state estimation device comprising:
at least one of (i) a circuit and (ii) a processor with a memory storing computer program code executable by the processor, the at least one of the circuit and the processor configured to cause the state estimation device to:
acquire image data from an imaging device;
calculate a first estimated value corresponding to an estimated value of a state of a movable body based on the image data, the state including at least one of a position, a velocity, and an orientation of the movable body;
acquire inertial data from an inertial measurement unit;
calculate a second estimated value corresponding to an estimated value of the state based on the inertial data;
calculate a Coriolis term corresponding to a Coriolis force based on the inertial data; and
calculate a final estimated value of the state based on the first estimated value, the second estimated value, and the Coriolis term.

2. The state estimation device according to claim 1, wherein the at least one of the circuit and the processor is configured to cause the state estimation device to:
estimate an absolute azimuth angle as the state based on the final estimated value.

3. The state estimation device according to claim 1, wherein the at least one of the circuit and the processor is configured to cause the state estimation device to:
calculate the final estimated value using visual inertial odometry based on tracking results of feature points extracted from camera images.

4. The state estimation device according to claim 1 is mounted on a vehicle as the movable body.

5. A state estimation method implemented by at least one of a processor and a memory to estimate a state including at least one of a position, a velocity, and an orientation of a movable body, comprising:
acquiring image data from an imaging device;
calculating a first estimated value corresponding to an estimated value of the state based on the image data;
acquiring inertial data from an inertial measurement unit;
calculating a second estimated value corresponding to an estimated value of the state based on the inertial data;
calculating a Coriolis term corresponding to a Coriolis force based on the inertial data; and
calculating a final estimated value of the state based on the first estimated value, the second estimated value, and the Coriolis term.

6. The state estimation method according to claim 5, further comprising:
estimating an absolute azimuth angle as the state based on the final estimated value.

7. The state estimation method according to claim 5, wherein the calculating of the final estimated value is performed by using visual inertial odometry based on tracking results of feature points extracted from camera images.

8. The state estimation method according to claim 5, wherein the movable body is a vehicle.

9. A non-transitory computer readable storage medium storing a state estimation program to estimate a state including at least one of a position, a velocity, and an orientation of a movable body, and comprising instructions configured to, when executed by a computer, cause the computer to acquire image data from an imaging device;
calculate a first estimated value corresponding to an estimated value of the state based on the image data;
acquire inertial data from an inertial measurement unit;
calculate a second estimated value corresponding to an estimated value of the state based on the inertial data;
calculate a Coriolis term corresponding to a Coriolis force based on the inertial data; and
calculate a final estimated value of the state based on the first estimated value, the second estimated value, and the Coriolis term.
